(19) United States
(12) Patent Application Publication
(10) Pub. No.: US 2014/0193710 A1
(43) Pub. Date: Jul. 10, 2014

(54) NON-AQUEOUS ELECTROLYTE SECONDARY BATTERY

(71) Applicant: Takuya Hasegawa, Sagamihara-shi (JP)

(72) Inventor: Takuya Hasegawa, Sagamihara-shi (JP)

(73) Assignee: NEC ENERGY DEVICES, LTD., Sagamihara-shi, Kanagawa (JP)

(21) Appl. No.: 14/241,775

(22) PCT Filed: Aug. 30, 2012
(86) PCT No.: PCT/JP2012/072005

§ 371 Date: Feb. 27, 2014

(30) Foreign Application Priority Data
Aug. 31, 2011 (JP) 2011-188263

(51) Int. Cl. H01M 2/26

(52) U.S. Cl. CPC H01M 2/26
USPC 429/211

(57) ABSTRACT

To provide a non-aqueous electrolyte secondary battery less subject to impact by vibration, impact, etc., and has stable characteristics. The non-aqueous electrolyte secondary battery includes: a positive electrode part in which a positive electrode active material layer is formed on a positive collector; a positive electrode which is provided with a positive electrode lead tab and which is integrally formed with the positive collector so as to be connected to a periphery of the positive electrode part through a curved portion continuing therefrom; a negative electrode part in which a negative electrode active material layer is formed on a negative collector; a negative electrode which is provided with a negative electrode lead tab and which is integrally formed with the negative collector so as to be connected to a periphery of the negative electrode part through a curved portion continuing therefrom; and a separator which is interposed between the positive and negative electrodes. A positive electrode active material layer is formed at least on both sides of the positive electrode lead tab, and a projection portion obtained by vertically projecting the positive electrode part on the negative electrode part exists inward an outline of the negative electrode active material layer.

### TECHNICAL FIELD

The present invention relates to a non-aqueous electrolyte secondary battery obtained by sealing, with a covering material, an electrode stacked body in which positive and negative electrodes are stacked through a separator.

### BACKGROUND ART

A non-aqueous electrolyte secondary battery, such as a lithium-ion battery, obtained by laminating positive and negative electrodes through a separator can be easily increased in capacity per unit battery by an increase in areas of the positive and negative electrodes or increase in the number of the positive and negative electrodes to be stacked, and is thus suitably used as a battery having a large charge/discharge capacity.

In the non-aqueous electrolyte secondary battery, such as a lithium-ion battery, the positive and negative electrodes each use a metal foil as a collector. Specifically, in the lithium-ion battery, the positive and negative electrodes are manufactured as follows: a slurry obtained by mixing a particulate active material, a conductive material, a binding agent, and the like is partially applied onto a surface of a strip-shaped metal foil, followed by drying, and the resultant collector is cut into a block each having a predetermined size such that a lead tab is integrally formed with a portion where an active material layer is not formed.

The positive and negative electrodes are stacked or wound around through a separator and accommodated in a battery container. At this time, since a thickness of the collector and a thickness of each of the positive and negative electrodes in which the active material is applied onto the collector are small, it is important to prevent the collector or electrode from being ruptured. Further, the lithium-ion battery is required to prevent a position of the positive or negative electrode from being displaced so as to prevent occurrence of dendrite in which lithium is precipitated on the electrode or occurrence of short-circuiting in which the positive and negative electrodes are brought into direct contact with each other.

To prevent the rupture of the collector foil, there is proposed a non-aqueous electrolyte secondary battery having a battery electrode in which a continuous curve is formed ranging from a periphery of a lead tab portion to a periphery of a portion having the active material layer to increase strength of a joint portion between the lead tab and portion in which the electrode active material layer is formed or in which occurrence of burr or rupture of the collector foil at a corner portion is prevented (see Patent Document 1).

Further, to prevent the displacement of the lamination position, there is proposed a stacked battery in which the positive and negative electrodes are stacked through the separator while determining the lamination position by using a partially cut or folded portion formed in the electrode or separator (see Patent Document 2).

### PRIOR ART DOCUMENT

### Patent Documents

[Patent Document 1] JP11-016577A

[Patent Document 2] JP2001-102050A

### DISCLOSURE OF THE INVENTION

### Problems to be Solved by the Invention

As described above, in the proposal of Patent Document 1, by forming the continuous curve ranging from the periphery of the lead tab portion formed integrally with each of the positive and negative electrodes of the non-aqueous electrolyte secondary battery such as a lithium-ion battery to periphery of the portion having the active material layer, strength of the joint portion between the lead tab electrode and portion in which the electrode active material layer is formed can be increased or rupture of the collector foil in a corner portion can be prevented. However, when strong vibration is repeatedly applied to the battery, a position of the battery electrode may be displaced to cause short-circuiting between the positive electrode lead tab and negative electrode, which may in turn cause a considerably large current to flow to a portion where the active material is not present.

Further, as described above, in the proposal of Patent Document 2, the use of a portion obtained by partially cutting the electrode facilitates positioning of the electrode. However, this configuration scarifies a battery capacity, disadvantageously affecting battery characteristics.

An object of the present invention is to provide a battery less likely to cause a problem such as the short-circuiting between the positive electrode tab and negative electrode due to displacement even when strong vibration is repeatedly applied to the battery.

### Means for Solving the Problems

The present invention has been made to solve the above problem, and the problem can be solved by a non-aqueous electrolyte secondary battery including: a positive electrode part in which a positive electrode active material layer is formed on a positive collector; a positive electrode which is provided with a positive electrode lead tab and which is integrally formed with the positive collector so as to be connected to a periphery of the positive electrode part through a curved portion continuing therefrom; a negative electrode part in which a negative electrode active material layer is formed on a negative collector; a negative electrode which is provided with a negative electrode lead tab and which is integrally formed with the negative collector so as to be connected to a periphery of the negative electrode part through a curved portion continuing therefrom; and a separator which is interposed between the positive and negative electrodes. A positive electrode active material layer is formed at least on both sides of the positive electrode lead tab, and a projection portion obtained by vertically projecting the positive electrode part on the negative electrode part exists inward an outline of the negative electrode active material layer.

In the non-aqueous electrolyte secondary battery according to the present invention, the positive electrode active material layer is formed on a surface of the positive electrode lead tab that faces the negative electrode.

In the non-aqueous electrolyte secondary battery according to the present invention, the curved portion has a curvature radius r of 1 mm to 10 mm with respect to the lengths of a drawing direction of the positive electrode lead tab and a vertical direction thereof.

The non-aqueous electrolyte secondary battery according to the present invention is a stacked battery obtained by laminating a plurality of the positive electrodes and a plurality of the negative electrodes through separators.

In the non-aqueous electrolyte secondary battery according to the present invention, an outer upper end portion of the negative electrode lead tab positioned in an upper end portion of a side of the negative electrode from which the negative electrode lead tab is positioned above an inner upper end portion of the negative electrode lead tab.

Note that, in the present invention, the outer upper end portion of the negative electrode lead tab refers to a portion of the negative electrode lead tab on an opposite side to the positive electrode lead tab, and the outer upper end portion of the negative electrode lead tab refers to a portion of the negative electrode lead tab on a side facing the positive electrode lead tab.

In the non-aqueous electrolyte secondary battery according to the present invention, the curved portion is a circular arc.

The non-aqueous electrolyte secondary battery according to the present invention is a lithium-ion secondary battery.

Note that the curved portion connected to the periphery of the positive or negative electrode part through a curve continuing therefrom means that a projected plane shape obtained by projecting the positive or negative electrode on a surface parallel to the positive or negative collector.

### Advantages of the Invention

According to the present invention, there is provided a non-aqueous electrolyte secondary battery including a positive electrode part in which a positive electrode active material layer is formed on a positive collector, wherein the positive electrode active material layer is formed in a region surrounded by curved portions positioned on both sides of the positive electrode lead tab which is integrally formed with the positive collector so as to be connected to a periphery of the positive electrode part through the curved portion continuing therefrom and wherein a negative electrode active material layer exists at a projection portion obtained by vertically projecting the positive electrode part on the negative electrode part; a negative electrode part in which a negative electrode active material layer is formed on a negative collector; and a negative electrode which is provided with a negative electrode lead tab and which is integrally formed with the negative collector so as to be connected to a periphery of the negative electrode part through a curved portion continuing therefrom. Thus, the positive- and negative-electrode lead tabs each have high strength. Further, the positive electrode active material layer is formed on the surface of the positive electrode lead tab that faces the negative electrode, so that even if large displacement occurs due to vibration or the like to bring the positive electrode lead tab into contact with the negative electrode lead tab, short-circuit current is reduced as compared to a case where the positive electrode lead tab is brought into direct contact with a negative electrode active material non-application part of the negative electrode lead tab, thereby avoiding severe trouble.

### BRIEF DESCRIPTION OF THE DRAWINGS

FIGS. 1A and 1B are views for explaining an embodiment of a non-aqueous electrolyte secondary battery according to the present invention, in which FIG. 1A is a front view and FIG. 1B is a cross-sectional view taken along a line A-A′ of FIG. 1A illustrating, in an enlarged manner, a lamination direction.

FIGS. 2A to 2D are views for explaining an example of negative and positive electrodes of the non-aqueous electrolyte secondary battery according to the present invention, in which FIG. 2A is a view for explaining the negative electrode, FIG. 2B is a view for explaining the positive electrode, FIG. 2C is a view for explaining a stacked body obtained by laminating the negative and positive electrodes through a separator, and FIG. 2D is a view for explaining an electrode stacked body.

FIG. 3 is a view for explaining a shape of a battery electrode of the present invention.

### MODE FOR CARRYING OUT THE INVENTION

The present invention will be described with reference to the drawings.

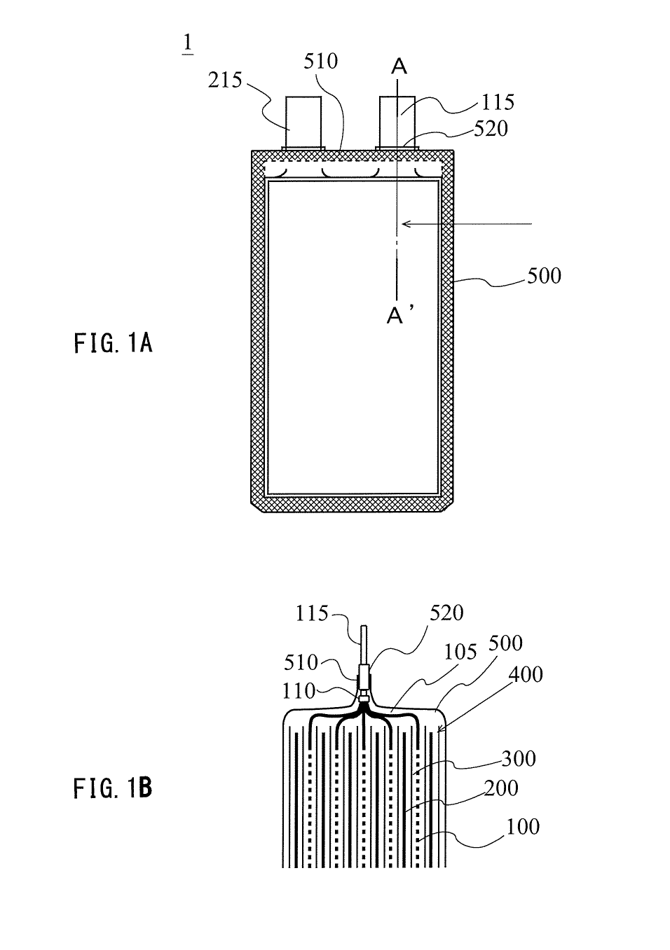

FIGS. 1A and 1B are views for explaining an embodiment of a non-aqueous electrolyte secondary battery according to the present invention. FIG. 1A is a front view, and FIG. 1B is a cross-sectional view taken along a line A-A′ of FIG. 1A, which illustrates, in an enlarged manner, a lamination direction.

A non-aqueous electrolyte secondary battery 1 includes an electrode stacked body 400 obtained by laminating a positive electrode 100 and a negative electrode 200 through a separator 300. A positive electrode lead tab 105 and a negative electrode lead tab (not illustrated) are drawn in the same direction.

A plurality of the positive electrode lead tabs 105 are overlapped one another and joined to a positive electrode tab 115 at a joint portion 110 by ultrasonic joining. Similarly, a plurality of the negative electrode lead tabs are joined to a negative electrode tab 215. The positive electrode tab 115 and negative electrode tab 215 joined to the electrode stacked body 400 in this manner are drawn from a sealing portion 510 of a film -like covering material 500.

The film-like covering material may be formed of a stacked body including a material having strength and heat resistance, such as nylon or polyethylene terephthalate, used for an outer surface side of an aluminum foil and a material having improved thermal adhesive characteristics, such as polypropylene or polyethylene, used for an inner surface of the aluminum foil. The covering material of the stacked secondary battery is not limited to the film-like covering material as described above, but a metal container may be used.

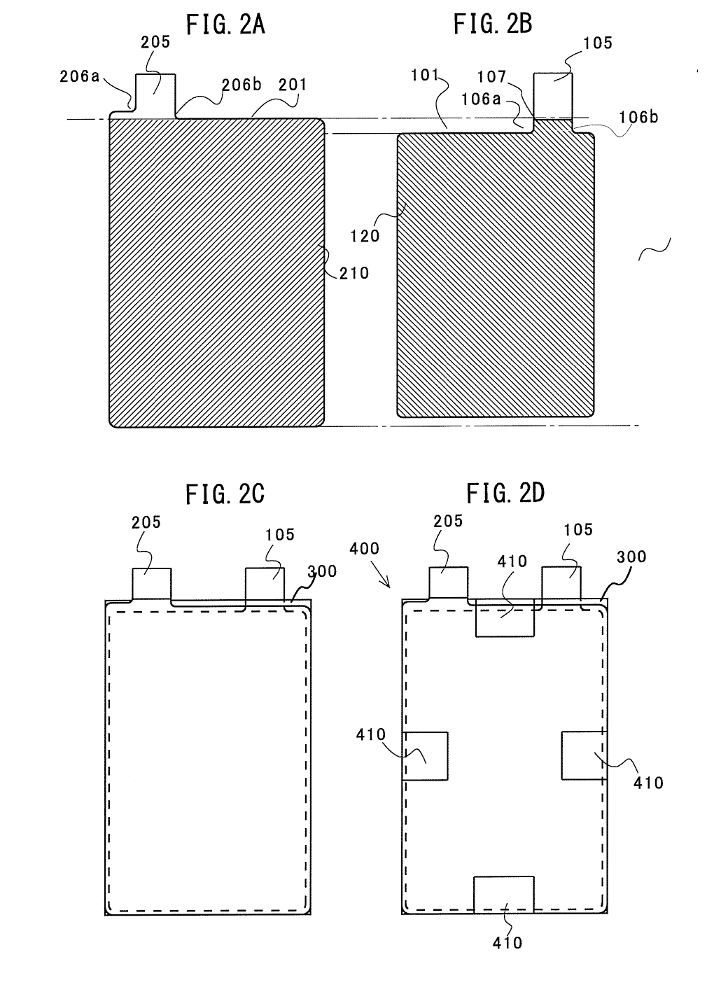

FIGS. 2A to 2D are views for explaining an example of the negative and positive electrodes of the non-aqueous electrolyte secondary battery according to the present invention.

FIG. 2A is a view for explaining the negative electrode.

The negative electrode is manufactured as follows: a slurry negative electrode mixture obtained by dispersing a carbon material that absorbs and releases lithium ions, a conductive material such as carbon black, a binding agent such as polyvinylidene fluoride into N-methyl-2-pyrrolidone is intermittently applied onto both surfaces of a negative collector formed of a strip-shaped copper foil, followed by drying, the resultant negative collector is compressed using a roller press for shaping, and an obtained negative electrode base material is cut into blocks each having a predetermined size.

The negative electrode 200 includes a negative electrode part 210 acting when the battery reacts and a negative electrode lead tab 205 integrally formed with a negative collector 201 of the negative electrode base material. The negative electrode lead tab 205 is connected to a periphery of the negative electrode part 210 through curved portions 206a and 206b continuing therefrom while forming curved surfaces.

FIG. 2B is a view for explaining the positive electrode. A slurry positive electrode mixture obtained by dispersing lithium-manganese composite oxide, lithium-cobalt composite oxide, or lithium-nickel composite oxide, a conductive material such as carbon black, and a binding agent such as polyvinylidene fluoride into N-methyl-2-pyrrolidone is intermittently applied onto both surfaces of a positive collector formed of a strip-shaped aluminum foil, followed by drying, and the resultant positive collector is compressed using a roller press for shaping to obtain a positive electrode base material.

The positive electrode 100 includes a positive electrode part 120 acting when the battery reacts and a positive electrode lead tab 105 integrally formed with a positive collector 101 of the positive electrode base material. The positive electrode lead tab 105 is connected to a periphery of the positive electrode part 120 through curved portions 106a and 106b continuing therefrom.

A positive electrode active material application part 107 is formed between the curved portions 106a and 106b so as to extend up to a portion facing a negative electrode active material. By forming the positive electrode active material at least between the curved portions 106a and 106b, strength of a boundary between the lead tab and electrode can be increased.

The curved portions formed on both sides of the negative electrode lead tab and those formed on both sides of the positive electrode lead tab each have a curvature radius r of 1 mm to 10 mm and, more preferably, 2 mm to 8 mm.

When the curvature radius is smaller than 1 mm, strength between the lead tab and collector is insufficient, so that rupture may disadvantageously occur when the positive- and negative-electrode tabs are subjected to ultrasonic joining. When the curvature radius is larger than 10 mm, an amount of the applied active material to be shed is increased, which may disadvantageously result in short-circuiting with the opposite electrode in some use conditions.

Subsequently, as illustrated in FIG. 2C, by a method that encapsulates the positive electrode 100 into the pouched separator 300 and then laminates the positive electrode 100 encapsulated in the separator 300 with the negative electrode 200, a plurality of the positive electrodes 100 and a plurality of the negative electrodes are stacked with each other through separators 300 and integrated by adhesive tapes 410. After that, a plurality of the positive electrode lead tabs are joined to one another by a method such as the ultrasonic joining and, similarly, a plurality of the negative electrode lead tabs are joined to one another, whereby the electrode stacked body 400 can be obtained.

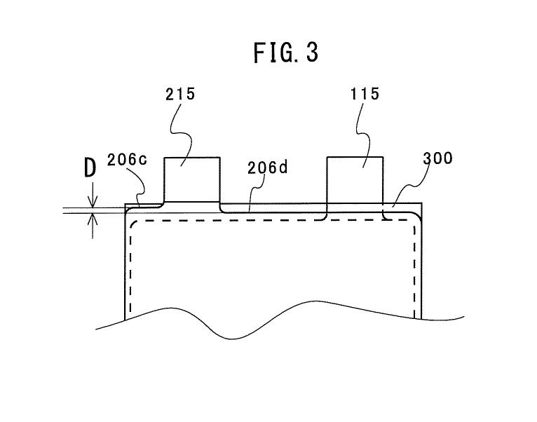

FIG. 3 is a view for explaining a shape of the battery electrode of the present invention on the electrode lead tab side.

Preferably, the stacked body of the present invention does not have a left-right symmetrical shape.

That is, in the negative electrode 200, an outer upper end portion 206c of the negative electrode lead tab positioned in an upper end portion of a side from which the negative electrode lead tab 205 is drawn has a deviation D with respect to a height position of an upper end of an inner upper end portion 206d.

Preferably, this deviation D has a size that can be utilized for positioning and is positioned below the upper end portion of the separator so as to prevent the active material from being brought into contact with the opposite electrode due to shedding. By making higher a height of the outside of the tab drawn from an electrode having a larger outer dimension, when the battery stacked body is covered by a member having an embossed shape such as a film-like covering material, the part of the electrode stacked body that has a higher height abuts against an embossed surface to thereby prevent displacement in the covering material.

The electrode stacked body produced in the manner as described above is then covered by a film-like covering material or accommodated in a battery container formed of metal and subjected to sealing after injection of electrolyte, whereby production of a battery is completed.

### INDUSTRIAL APPLICABILITY

The non-aqueous electrolyte secondary battery according to the present invention includes a positive electrode part, wherein a positive electrode active material layer is formed in a region surrounded by curved portions positioned on both sides of a positive electrode lead tab which is integrally formed with a positive collector so as to be connected to a periphery of the positive electrode part through the curved portion continuing therefrom and wherein a negative electrode active material layer exists at a projection portion obtained by vertically projecting the positive electrode part on the negative electrode part; a negative electrode part in which a negative electrode active material layer is formed on a negative collector; and a negative electrode which is provided with a negative electrode lead tab and which is integrally formed with the negative collector so as to be connected to a periphery of the negative electrode part through a curved portion continuing therefrom. Thus, the positive- and negative-electrode lead tabs each have high strength. Further, the positive electrode active material layer is formed on the surface of the positive electrode lead tab that faces the negative electrode, so that even if large displacement occurs due to vibration or the like to bring the positive electrode lead tab into contact with the negative electrode lead tab, short-circuit current is reduced, thereby avoiding severe trouble.

### EXPLANATION OF REFERENCE SYMBOLS

1: Non-aqueous electrolyte secondary battery

100: Positive electrode

101: Positive collector

105: Positive electrode lead tab

106a, 106b: Curved portion

107: Positive electrode active material application part

110: Joint portion

120: Positive electrode part

200: Negative electrode

201: Negative collector

210: Negative electrode part

205: Negative electrode lead tab

206a, 206b: Curved portion

206c: Outer upper end portion

206d: Inner upper end portion

300: Separator

400: Electrode stacked body

410: Adhesive tape

500: Film-like covering material

510: Sealing portion

1-8. (canceled)

9. A non-aqueous electrolyte secondary battery comprising:
a positive electrode part in which, a positive electrode active material layer is formed on a positive collector;
a positive electrode which is provided with a positive electrode lead tab and which is integrally formed with the positive collector so as to be connected to a periphery of the positive electrode part through a curved portion continuing therefrom;
a negative electrode part in which a negative electrode active material layer is formed on a negative collector;
a negative electrode which is provided with a negative electrode lead tab and which is integrally formed with the negative collector so as to be connected to a periphery of the negative electrode part through a curved portion continuing therefrom; and
a separator which is interposed between the positive and negative electrodes, characterized in that
a positive electrode active material layer is formed at least on both sides of the positive electrode lead tab,
a joint portion between the positive electrode lead tab and collector has a curved portion, and
the positive electrode active material layer is formed in a region surrounded by the curved portions on both sides of the positive electrode lead tab.

10. The non-aqueous electrolyte secondary battery according to claim 9, characterized in that
a projection portion obtained by vertically projecting the positive electrode part on the negative electrode part exists inward an outline of the negative electrode active material layer.

11. The non-aqueous electrolyte secondary battery according to claim 9, characterized in that
the positive electrode active material layer is formed on a surface of the positive electrode lead tab that faces the negative electrode.

12. The non-aqueous electrolyte secondary battery according to claim 9, characterized in that
the curved portion has a curvature radius r of 1 mm to 10 mm with respect to the lengths of a drawing direction of the positive electrode lead tab and a vertical direction thereof.

13. The non-aqueous electrolyte secondary battery according to claim 9, characterized by being a stacked battery obtained by laminating a plurality of the positive electrodes and a plurality of the negative electrodes through separators.

14. The non-aqueous electrolyte secondary battery according to claim 9, characterized in that
an outer upper end portion of the negative electrode lead tab positioned in an upper end portion of a side of the negative electrode from which the negative electrode lead tab is positioned above an inner upper end portion of the negative electrode lead tab.

15. The non-aqueous electrolyte secondary battery according to claim 9, characterized in that
the curved portion is a circular arc.

16. The non-aqueous electrolyte secondary battery according to claim 9, characterized by being a lithium-ion secondary battery.
